(19) United States
(12) Patent Application Publication
(10) Pub. No.: US 2006/0035061 A1
(43) Pub. Date: Feb. 16, 2006

(54) Insole

(75) Inventors: Rainer Mangold, Herbrechtingen (DE); Angela Rompp, Zell (DE); Jana Michelmann, Heidenheim (DE)

Correspondence Address: DREISS, FUHLENDORF, STEIMLE & BECKER, POSTFACH 10 37 62, D-70032 STUTTGART, DE

(73) Assignee: Paul Hartmann AG, Heidenheim (DE)

(21) Appl. No.: 10/522,411

(22) PCT Filed: Jul. 25, 2003
(86) PCT No.: PCT/EP03/08217

§ 371 Date: Jan. 26, 2005

(30) Foreign Application Priority Data
Jul. 29, 2002 (DE) 102 35 511.8

(51) Int. Cl. B32B 3/00

(52) U.S. Cl. 428/156

(57) ABSTRACT

An insole (for shoes) is in the form of a disposable product having a maximum thickness of 3 mm and consisting essentially of a liquid-absorbing fiber fleece material made of or based on cellulose fiber. The insole is formed by a single wadding fleece layer (4) made of cellulose fiber material having 25% by weight of heat meltable binding fibers, the layer being compacted by means of embossing calendaring and having highly compacted embossed areas (9) as well as other areas (10) which are less compacted in comparison therewith.

The invention concerns an insole for shoes fashioned as a disposable product having a thickness of not more than 3 mm with a liquid absorbing non-woven fiber layer including or consisting essentially of a cellulose fiber material basis.

An insole of this type has been disclosed in EP 0414634B1. The insole includes a liquid absorbing non-woven fiber layer of cotton fibers which can also have heat meltable binding fibers as an additive. In addition, a stabilizing layer faces the inner sole of the shoe to stiffen the sole and prevent slippage. An additional covering layer is disposed on the other side of the non-woven fiber layer facing away from the stabilizing layer. The insole 2 has a plurality of holes or openings which pass through all layers.

EP 0033448A1 discloses an insole made from an absorptive paper material having an antibacterial side and/or a fungicide and/or odor eliminating agents.

EP 0216727A2 discloses and teaches an insole made from at least four layers: a slip-resistant lower most foam material layer, an intermediate layer made from a non-woven material seating thereon, an absorptive layer made from a plurality of layers of wad material, and a covering layer also made from a non-woven material.

EP0272690A2 also discloses a multi-layer construction for a disposable insole having a non-woven fiber layer based on cellulose with heat meltable polypropylene or polyester spin fibers.

It is the underlying purpose of the present invention to propose an insole which is simple to manufacture from a processing point of view, which can be inexpensively produced and which is distinguished through proper use characteristics.

This purpose is achieved with the insole having the features of claim 1.

In accordance with the invention, it has been determined that an emboss calendaring of only one single non-woven fiber layer in the form of a wad fleece layer in accordance with claim 1, leads to a sufficiently stable composite suitable for use as an insole and having excellent characteristics. Although EP0033448A1 refers to its insole as a paper fleece product, in accordance with the definitions and standards of EDANA and ISO 9092 EN 29062, paper products are not fiber fleece or non-woven products: the definition of EDANA as of February 1999 for non-woven or fiber fleece materials explicitly excludes paper products.

An insole in accordance with the invention preferentially has a thickness of 1-3 mm, in particular 1.1 to 1.4 mm, wherein the thickness is to be determined under a measurement pressure of 20 g/cm². Towards this end and also in order to calculate the density from the thickness and the surface density of the flat test object of the emboss calendar wad fiber layer, the test material is initially stored for 24 hours at 105° C. in a dry cabinet and is subsequently allowed to cool in a desiccator. It is then weighed and the thickness measured under a test pressure of 20 g/cm². Densities of 0.1 to 0.5 g/cm², in particular of 0.2 to 0.3 g/cm² are preferred for the emboss calendar wad fleece layer. The surface density of the wad fleece layer preferentially assumes values of 200 to 500 g/m².

During emboss calendaring of the wad fleece layer, emboss calendar rollers having raised structures producing the embossment occupy 8 to 20%, in particular 10 to 16% of the roller surface and of the surface of the insole. The deepness of the embossments and the height of the raised portions is at least 0.5 mm. The smallest dimensions for the raised structures and for the emboss structures resulting therefrom of 0.3 to 0.6 mm have turned out to be advantageous and are preferred. Structures can also be points or could be elongated raised structures on the calendar roller which subsequently produce elongated highly compressed embossed regions of several mm, in particular 2 to 6 mm in length.

The largest tensile force in an insole in accordance with the invention in the longitudinal direction and in the dry state preferentially assumes values of 35 to 100 N/25 mm, in particular 50 to 80 N/25 mm and in the transverse direction, 40 to 100 N/25 mm, in particular 55 to 80 N/25 mm. This maximum tensile force can be determined utilizing a standardized tensile testing machine in according with DIN 51221. A calendar embossed sample which is to be tested having a clamped width of 25 mm and a clamped length of 30 mm is removed from the wad fleece layer. The sample is clamped in the clamped receptacles in the standardized tensile testing machine and is then pulled apart with a testing speed of 100 mm/min in a plane of its longitudinal extension during the course of which the tensile force in this direction is measured. One can preferentially carry out a plurality of measurements, in particular measurements when determining the longitudinal and transverse directions which correspond to the machine direction and to the direction transverse thereto and then taking an average value of these results. The maximum tensile strength is understood to be that maximum strength at which the wadded pad tears. In the event that higher force peaks occur during the expansion procedure, then these higher force peaks define the maximum tensile force within the meaning of this test.

Furthermore, the insole in accordance with the invention has a maximum tensile force in a moist condition which assumes values in the longitudinal direction of 20 to 80 N/25 mm, in particular 35 to 70 N/25 mm and, in the transverse direction, 30 to 80, in particular 40 to 55 N/25 mm. In order to determine the maximum tensile force in the moist state, the sample under investigation is soaked in water and allowed to drip for 5 seconds.

It is furthermore advantageous when the insole in accordance with the invention has a water absorption capability of 1 to 4 g/g, preferentially 1.5 to 3 g/g (g liquid per g of wad fiber layer material). In order to determine this water absorption capacity in accordance with DIN 53923, samples of 100×100 mm are stamped out of the wad fleece layer. Prior to testing, the samples are conditioned for at least 24 hours at 23° C. and 50% relative humidity. The dry weight of the sample is then determined (M1). (In the event that an individual sample weighs less than 1 g, a plurality of samples are stacked together into a sample pile which must weigh at least 1 g). The samples obtained in this fashion are inserted into a wire basket and loaded with a flat steel plate (100×100×2 mm). The wire basket is submerged in demineralized water together with the sample and the plate. The sample remains in the water for 30 seconds while being loaded by the plate. The plate is then removed and the sample remains in the liquid for a further 30 seconds without the load. The wire basket is then removed from the liquid together with the sample and one allows the liquid to drip off from a corner for 120 seconds. The sample is then remeasured (M2). The water absorption capacity is then determined using DIN standard 53923 in accordance with (M2−M1)/M1×100 in percent).

Moreover, it has turned out to be particularly advantageous when the insole in accordance with the invention has a very high internal strength of >170 N/25 cm², in particular >180 g/25 cm², and preferentially >190 N/25 cm², which is determined in the following manner. The testing procedure is intended to determine when and under what conditions the insole is destroyed. Towards this end, a tensile testing machine in accordance with DIN 51221 class 1 as well as two auxiliary sheets of material and double-sided sticky tape are utilized. A flat circular test sample of 57 mm diameter is glued between an upper and a lower auxiliary thin plate using the double-sided tape. A t-shaped handle which can be clamped is attached to each plate. The two auxiliary thin plates are clamped into the tensile testing machine and pulled apart with a speed of 100 mm/m. During the course thereof, the maximum tensile strength is determined. The maximum tensile strength is defined as the force at which the pad is torn apart. If higher or larger force peaks occur during the course of the expansion prior to tearing, then these forced peaks define the maximum tensile force within the context of this test.

The double-sided sticky tape is a tape made by 3M Corporation (tape 410) having a natural rubber gluing layer and with a defined gluing force of 19.3+2.2 N/25 mm in accordance with the Deutsche Arzneibuch [German Pharmaceutical Book] 1996 (see the pull-off method as described therein).

A section of the double-sided tape is applied to both the upper and lower sides of the wad fleece layer of the insole in accordance with the invention or on another insole which is to be tested. Towards this end, a laminate consisting of the wad fleece layer or the insole and the tape is preferably formed and round wad pads of non-woven material having tape on both sides are stamped out of this laminate. The compound material extracted in this manner (subsequent to removing the outer protective coatings for the glue) is then positioned between the two auxiliary thin plates and centered therein. The thin plates are then loaded with 30 kg for 2 minutes so that the composition consisting of the insole, the double-sided sticky tape and the auxiliary thin plates are connected to each other. This composite material is then clamped into the tensile testing machine in accordance with DIN 51221 and the clamps are pulled apart at the above mentioned speed of 100 mm/min to determine the tensile force. An average value is formed from at least 5 individual measurements and given in N.

In order to make the measurements reproducible, the gluing force of the double-sided sticky tape in accordance with the above mentioned pull-off method is standardized as determined by the Deutsche Arzneibuch 1996. Towards this end, the force that is necessary to pull off the tape (e.g. adhesive bandaging tape) from a flat substrate at an angle of 180 degrees and at a constant speed is measured. Towards this end, a tensile testing machine in accordance with DIN 51221 class 1 is utilized. Plates made from rust-free steel 150×50×2 mm are mechanically polished and roughened in the longitudinal direction for use in these tests.

The test is carried out at 23° C. and 50% relative humidity. Prior thereto, the samples are stored for 24 hours under these standard conditions. Prior to testing, the steel plates are soaked in toluol, cleaned with a swab, and subsequently brought into contact with the vapors of boiling toluol in a suitable container without coming into direct contact with this liquid. The vapors are incident on the surface of the plates for 5 minutes. The plates are then allowed to cool for 30 minutes in a standard environment.

Subsequent thereto, strips of 400 mm in length and predetermined width of the roll of 12.5 or 25 mm are cut to size and introduced onto the cleaned metal plates in such a fashion as to avoid air inclusions. Using a “tape applicator” the tape strips are rolled on under a pressure of 20 N/cm having the width of the sample (whereby the back side cover of the tape has not yet been removed). Following 10 minutes of waiting time, the measurement is carried out.

To carry out the measurement, the upper free end of the sample strip is peeled back and approximately 25 mm is pulled of from the upper end of the steel plate. An end of the steel plate is clamped into the upper clamp of the tensile test machine and the folded back end of the sample strip is clamped in the lower clamp of the tensile testing machine. The peeling of angle therefore assumes values of 180 degrees wherein one must take care that the back sides of the samples are mutually parallel and do not touch or rub against each other. The tensile testing machine is adjusted to a pull-off speed of 300±30 mm/min.

In order to determine the gluing force, the force time dependence is determined and recorded. From the force peaks, the average gluing force is determined from the procedures A) through C) described below.

If the dependencies of the curves deviate, one should utilize the procedures A) and B) as described below. In such cases, the evaluation procedure should be specified along with the results.

Evaluation Procedure C:

This procedure is to be used when the diagram has more than 20 clearly recognizable force peaks.

Use of this procedure requires that the fluctuations within the diagram are not periodic. Should this be the case, one should use evaluation procedure B).

Departing from the middle of a diagram length l which extends from the first force peak up to the point of tearing, one should introduce four perpendicular lines at equal separations of 1/10 of the length of this diagram line towards both sides.

These separations should be rounded to the next full millimeter. The nine peak values which are closest to these lines are to be used for determining the gluing force.

Isolated peak values which jut out to an extreme extent beyond the normal dependence of the curve should not be considered during the evaluation.

The results should be determined as an average value of at least 5 measurements given in N/25 mm and rounded to one digit following the decimal point.

scraping device

Additional stipulations are permissible.

The gluing force is then determined as follows

$$F = \frac{{\sum }_{i = 1}^{n} {F}_{i}}{n}$$

Fᵢ=force peaks F₁, F₂ . . . F_{N}
N=the number of force peaks evaluated

The evaluation can also be carried out with a suitable PC program.

Evaluation Procedure A:

One should utilize this procedure in the event that the diagram has up to 5 clearly differing force peaks. One determines the average value from these force peak values.

In the event that the diagram only has one single force peak its value is to be identified with the “average value”.

Evaluation Procedure B:

This procedure should be utilized in the event that 6-10 clearly distinguishable force peaks appear in the diagram.

The peak values of the intermediate 80% of that diagram region which begins with the first force peak and which ends with tearing off are utilized to determine the gluing force.

As already mentioned, the above description and definition of the gluing force serves to generate standardized and reproducible conditions for the tape which is to be utilized during the above mentioned internal strength test.

It has turned out to be particularly advantageous when the internal strength of the insole in accordance with the invention is >170, preferentially >180 and in particular >190 N/25 cm². Whereas in conventional multi-layer products, both the upper side layer of the insole as well as the layer on the lower side of the insole detach at an internal strength value significantly less than 170 N/25 cm², with the insole in accordance with the invention, the tape detaches together with only individual wad fleece layer fibers, with no separation of the layer itself having been observed, and this at higher values of on the average 220 N/25 cm with a standard deviation of 29 N/25 cm².

The insole in accordance with the invention is thereby distinguished by excellent internal strength and good internal retention of the wad fleece layer.

The insole in accordance with the invention has also displayed advantageous properties in burling test experiments utilizing a crock meter (a rubbing device test as described in DIN ISO 105-X12). Towards this end, a non-woven layer is rubbed with a defined standard test fabric. The damage to the sample surface is thereby observed visually. Towards this end, three sections of 14 by 5 cm are removed from the non-woven material to be tested with the longer side traveling in the machine direction. The pin of the above mentioned rubbing device is spanned with the rubbing fabric. Towards this end, a testing fabric called “Feinripp” made by the company Schiesser number 4467 has been utilized. The sample is fixed to the rubbing device with the assistance of holding clamps. The pin is moved back and forth over a length of 10 cm until the first holes are formed. Following a total of 10 rubbing cycles, the first visual evaluation of the sample surface is made and after 30 cycles, the second observation and evaluation. Towards this end, the load on the pin is 400 g/cm². During testing in a moisten state, the rubbing fabric is adjusted to 100% liquid absorptivity whereby the moisturizing corresponds to DIN EN ISO 105-X12.

This rubbing and burling experiment shows no formation of burls in the wad fleece layer of the insole in accordance with the invention following 30 rubbing cycles.

Further details, advantages and features of the invention can be extracted from the associated patent claims and from the illustrations and the subsequent description of preferred embodiments of the invention.

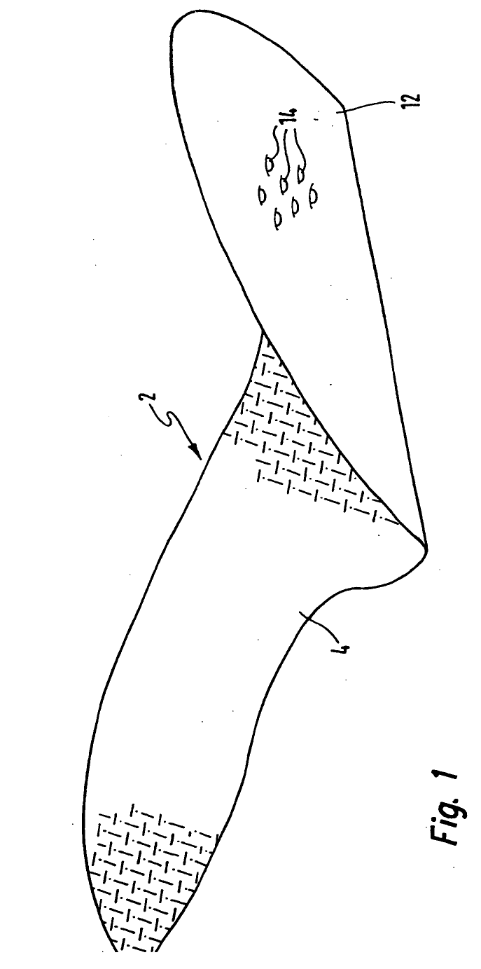

FIG. 1 shows a perspective view of an insole in accordance with the invention;

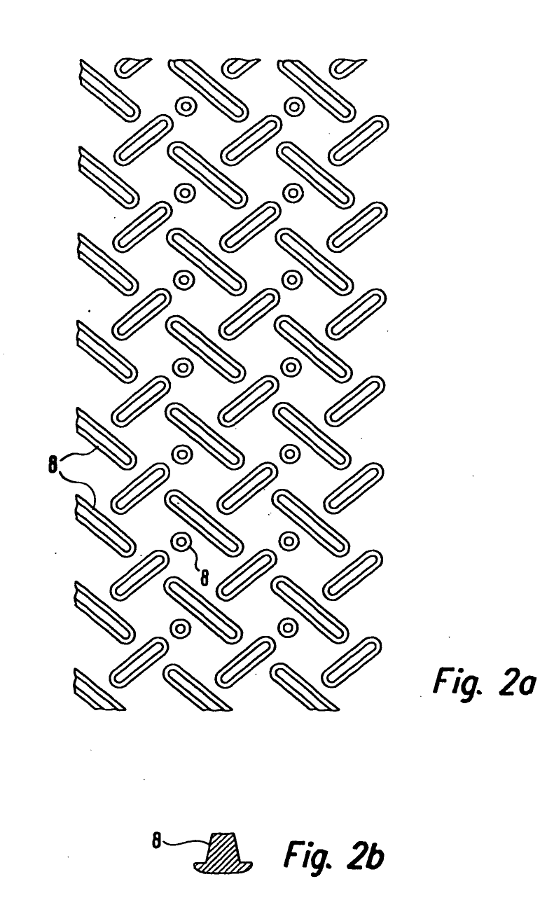

FIG. 2a shows a plan view of the embossed structure of a calendar roller;

FIG. 2b shows a detail of FIG. 2a;

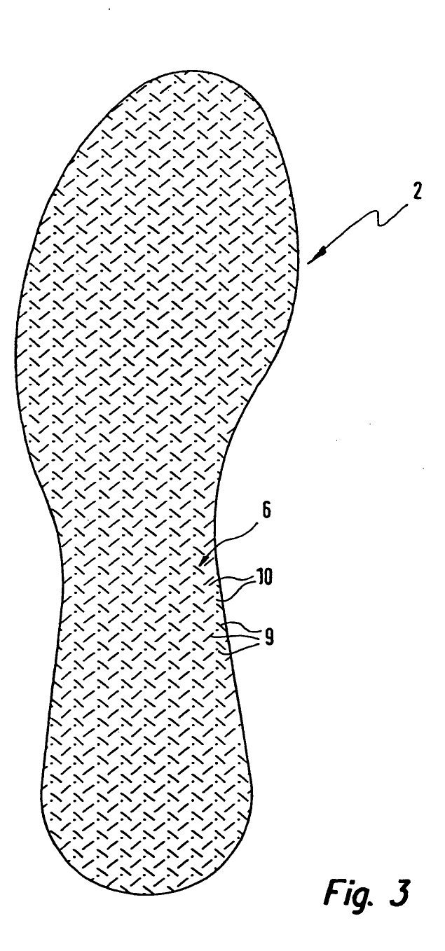

FIG. 3 through 5 show various surface structures for the insole in accordance with the invention;

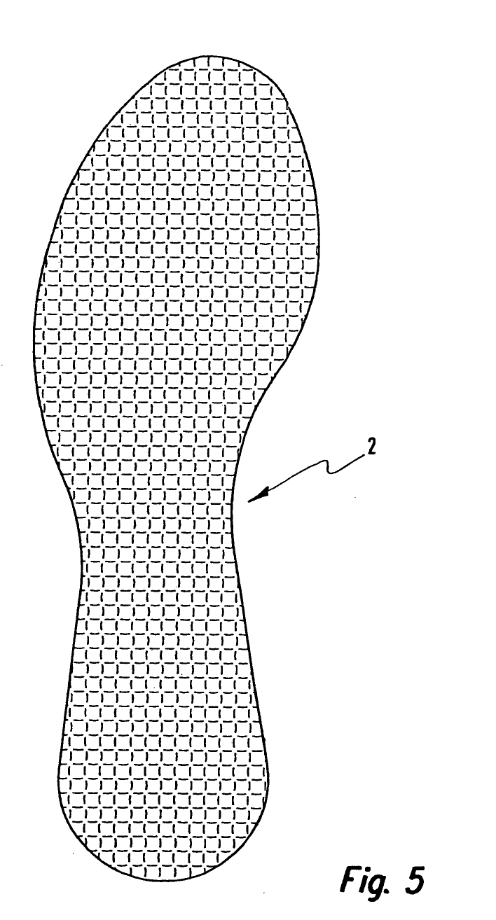

FIG. 6 through 8 show plan views and details of various surface structures;

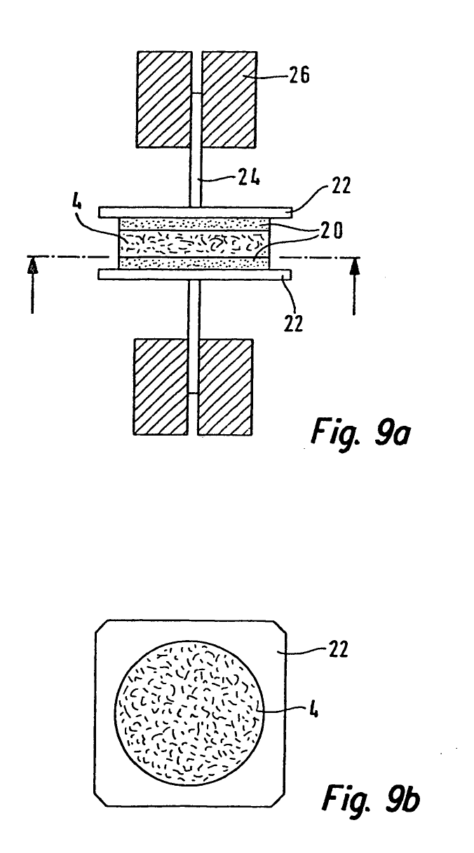

FIGS. 9a and 9b illustrate the testing set-up for measuring the internal strength of the non-woven fiber layers.

FIG. 1 shows a perspective view of an embodiment of the insole 2 in accordance with the invention. The insole 2 is made from one single wad fleece layer 4 comprising 50% by weight cotton fibers and 50% by weight polyethylene/polypropylene bi-component fibers (PE/PP). The wad fleece layer 4 is strengthened by embossment calendaring, i.e. it is passed between a heated calendar roller with protruding embossments and a calendar pressure roller. The surface structure visible in the figure is formed in this manner, in the case shown, with dots and elongated embossments 6.

FIG. 2a shows a plan view of a corresponding structure of the calendar roller in the scale of 5:1 and FIG. 2b shows a detail section of the surface structure. The engraving depths, i.e. the height of the elevations 8 on the surface of the roller, assume values of 0.7 mm in the case shown. The fraction of the elevations 8 on the roller surface, the so-called pressing surface fraction, is approximately 17 to 18% in this case.

FIG. 3 shows a plan view of a surface structure similar to that of FIG. 2 made by embossment calendaring of an insole 2 such as that shown in FIG. 1. The elevations on the calendar roller form highly compressed embossment regions 9 in addition to less compressed regions 10. The fraction of a highly compressed regions 9 in the overall surface is 10 to 11% in this case.

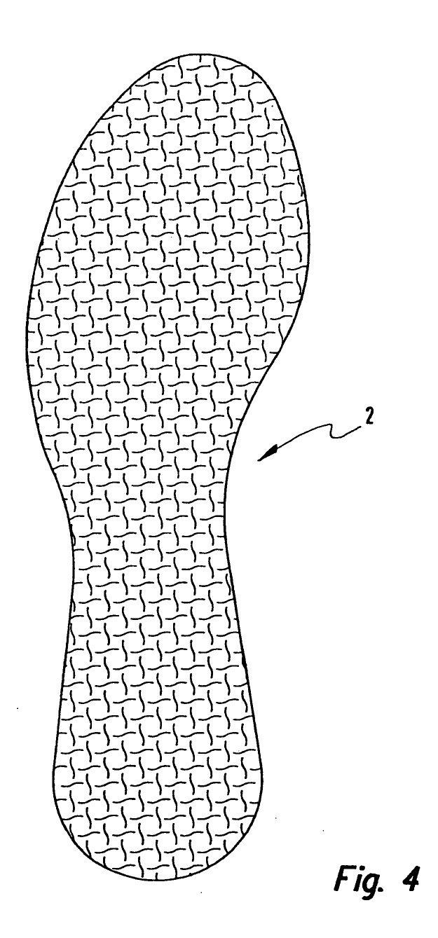

FIGS. 4 and 5 show additional embossment structures which have turned out to be advantages for the manufacture of an insole in accordance with the invention. In FIG. 4, the pressing surface fraction assumes values of approximately 12.5% and in FIG. 5 approximately 13.3%.

Embossment calendaring using a heated calendar roller having the above mentioned elevations 8 leads to at least a partial melting of the surfaces of the heat meltable binding fibers such that a thermal strengthening of the wad fleece layer thereby occurs. It is surprisingly turned out that it is thereby possible to produce an insole having exceptionally good internal strength in the sense of the above mentioned definition, namely in excess of 190 N/25 cm². With a conventional insole made by the company Flava, measurements of the internal strength only lead to values which are significantly less than 170 N/cm² with the average value being below 130 N/cm². In the conventional shoe sole, both the layer on the upper side of the sole as well as a layer on the lower side of the sole become detached, whereas in the insole described above in accordance with the invention, only the tape becomes detached together with a view individual fibers. There is no separation, however, of the one single fiber fleece layer. The surface density of the fiber fleece layer assume values of 200 to 500 g/m². The compressing of the wad fleece layer by calendar embossment is such that a density of the overall wad fleece layer between 0.1 to 0.5 g/cm³, preferentially between 0.2 and 0.3 g/cm³ is achieved, whereby the test object is cut in sections of 100×100 mm and initially stored for 24 hours at 105° C. in a dry closet and then allowed to cool in a desiccator. The samples are then subsequently weighed to an accuracy of 0.1 g. The thickness of the test object is then determined to an accuracy of 0.1 mm using a thickness measuring apparatus under a testing pressure of 20 g/cm² and the density is then calculated from this value.

Closely spaced island shaped nubs 14 are introduced onto the lower side 10 of the insole 2 facing away from the sole of the foot and adjacent to the insole of the shoe using silk screen or rotational press methods. These nubs are made from natural or synthetic rubber, from a watery acrylate-based dispersion, or from an acrylate/latex mixture, in particular from acrylate nitril latex mixture or from polyurethane or a polyurethane-acrylate mixture or from nitril latex and are therefore also distinguished from the lower side 12 of the insole with respect to their color. In the example shown, the nubs are dot-shaped or circular shaped and have a diameter of less than 1 mm. They therefore provide means to prevent slippage of the insole 22. Linear-shaped slippage preventing means are also conceivable.

The insole is moreover saturated with a solution containing methyl-β-cyclodextrine-aromatic material as a complex solution. The solution can comprise farnesole or some other active ingredient such as ether oils, aldehyde or combination of aldehydes that have a deodorizing effect. A deodorizing ester made from aromatic alcohols and aromatic carbon acids can be added, which also has an antimicrobial effect. Such material can also be used together with an aromatic agent and the above mentioned methyl-β-cyclodextrine complex in the event that, as is the case for farnesole, it is easily evaporated.

In order to reduce the risk of athletes foot, an active fungicide ingredient can be added to the complex solution such as undecelenamide (DEA).

In the event that an aromatic agent is utilized in the form of methyl-β-cyclodextrine complexes, this material hinders rapid evaporation of the aromatic agent and guarantees a long-working aroma. The aromatic agent is released from the methyl-β-cyclodextrine complex in response to heat and moisture (foot perspiration) when the shoe is removed. Organic components of foot perspiration can also be advantageously complexed on the released cyclo-dextrine molecules, in particular when the sole of the shoe is dried. In this manner, unpleasant odors can be avoided.

The addition of farnesole or another anti-microbial active ingredient blocks bacteria which decompose the foot perspiration and lead to the triggering of foot perspiration odor to prevent the effects thereof. One notes the addition of the above mentioned agents can be effected independent of the actual embossment structures 6 of the insole 2 and be utilized in each insole 2 in accordance with the invention.

It is turned out to be particularly advantageous when the inner sole in accordance with the invention is formed from the above mentioned single wad fleece layer 4 and without an additional covering layer facing the foot. In this manner, a thin and nevertheless non-burling (see the rubbing experiments) product can be obtained which has high internal strength.

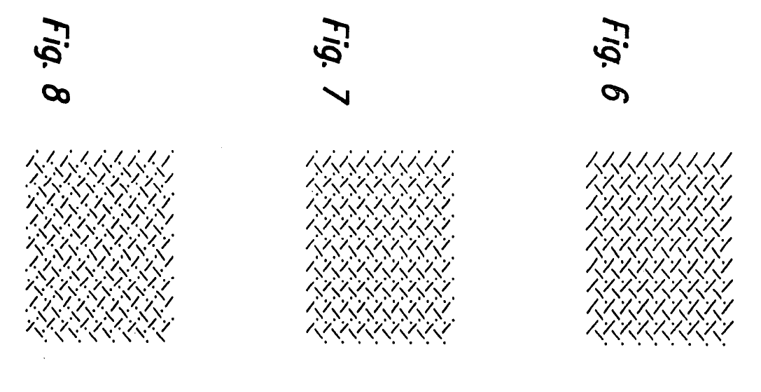

FIGS. 6, 7 and 8 show different surface structures of an insole in accordance with the invention with FIG. 6 showing a surface structure similar to that of FIG. 3. The surface structure according to FIGS. 7 and 8 differs to a slight extent. One can also see, in enlarged detail, the configuration and dimensioning of the highly dense embossed regions 9 and the regions which are less dense 10 compared thereto.

FIG. 9 schematically shows an experimental set-up of the testing methods described above for determining the internal strength of the wad fleece layer and of the insole. One observes the disk shaped sample of the wad fleece layer 4 as well as the neighboring double-sided tape 20 and the auxiliary thin plates 22 which, with their protruding handles 24 which are introduced to and clamped in the clamping receptacles 26 of the tensile testing machine.

In accordance with the preferred embodiment of the described shoe insole 2 in accordance with the invention having the above mentioned composition, the one single wad fleece layer 4 is embossed calendared under a embossment pressure of 400 N/mm. Assuming a surface density of 303 g/m², this leads to a non-woven material thickness in the embossed calendar state of the insole of 1.28 mm. The maximum tensile force in the dry state of 54.6 N/25 mm in the longitudinal direction and of 68.9 N/25 mm in the transverse direction has been determined. The water retension capacity assumes values of 1.7 g liquid per g of wad fleece layer.

Precisely the same measurements were then carried out with an insole which has been treated in the above mentioned fashion with an aromatic mixture and which has the above described nubs 14 on a lower side 12 thereof. In this case, the determined surface density assumes values of 338 g/m². The fleece thickness was measured to be 1.22 mm. The determined values of the maximum tensile force in the longitudinal direction were 49.9 N/25 mm and in the transverse direction 63.7 N/25 mm. In the moist state, the values were 36.0 N/25 mm in the longitudinal direction and 47.0 N/25 mm in the transverse direction. The water retention capacity assumes values of 1.8 g/g. In each case, an average value of at least 5 measurements was determined.

1-13. (canceled)

14. An insole for shoes designed as a disposable product having a thickness of at most 3 mm and with a liquid absorbing non-woven fiber layer including or based on cellulose fiber material, the insole comprising:
one single wad fleece layer having a cellulose-type fiber material with at least 25% per weight of heat meltable binding fibers, the layer being strengthened by calendar embossment to produce highly compressed embossed regions of high density and regions of lower density.

15. The insole of claim 14, wherein the insole has a thickness of 1-3 mm.

16. The insole of claim 15, wherein the insole has a thickness of 1-2 mm.

17. The insole of claim 14, wherein the insole has a density of 0.1-0.5 g/cm³.

18. The insole of claim 17, wherein the insole has a density of 0.2-0.3 g/cm³.

19. The insole of claim 14, wherein said highly compressed embossed regions constitute a fraction of 8-20% of a surface of said fleece layer.

20. The insole of claim 14, wherein said highly compressed embossed regions have a depth of at least 0.5 mm and a smallest dimension in a planar direction of 0.3-0.6 mm.

21. The insole of claim 14, wherein a maximum tensile force of said fleece layer in a dry state is 35-100 N/25 mm in a longitudinal direction and 40-100 N/25 mm in a transverse direction.

22. The insole of claim 14, wherein a maximum tensile pressure of said fleece layer in a moistened state is 20-100 N/25 mm in a longitudinal direction and 30-80 N/25 mm in a transverse direction.

23. The insole of claim 14, wherein the insole has a water retention or acceptance capacity of 1-4 gram liquid per gram of said fleece layer.

24. The insole of claim 14, wherein the insole has an internal strength of >170 N/25 cm².

25. The insole of claim 24, wherein the insole has an internal strength of >180 N/25 mm².

26. The insole of claim 14, wherein said fleece layer comprises cotton fibers.

27. The insole of claim 14, wherein said heat meltable binding fibers comprise multi-component fibers, polyethylene (PE), polypropylene (PP), and/or polyester (PES).

28. The insole of claim 14, further comprising island-shaped or linear shaped slippage prevention means on a lower side of the insole facing an insole of a shoe in a state of use.

29. The insole of claim 28, wherein said slippage prevention means have a maximum size of 1.5 mm.

30. The insole of claim 28, wherein said slippage prevention means have a maximum size of 1 mm.
